(19) United States
(12) Patent Application Publication
(10) Pub. No.: US 2015/0372948 A1
(43) Pub. Date: Dec. 24, 2015

(54) PARALLEL PATH TRAIN COMMUNICATION NETWORK

(71) Applicant: Electro-Motive Diesel, Inc., LaGrange, IL (US)

(72) Inventor: Mark Alan FANARA, Blue Springs, MO (US)

(21) Appl. No.: 14/312,854

(22) Filed: Jun. 24, 2014

(51) Int. Cl. H04L 12/931; H04L 29/08; H04L 12/823; H04W 28/08; H04L 12/947

(52) U.S. Cl. CPC H04L 49/351; H04W 28/08; H04L 49/25; H04L 47/32; H04L 67/12; H04W 88/08

(57) ABSTRACT

A communication access point is disclosed for use with a mobile consist having at least a first vehicle and a second vehicle. The communication access point may have an intra-consist router configured to receive signals from a first plurality of vehicle control components located onboard the first vehicle and to generate data packets for transmission to a second plurality of vehicle control components located onboard the second vehicle. The communication access point may also have a wired Ethernet bridge configured to transmit data packets to and from the intra-consist router, and a wireless Ethernet bridge configured to transmit data packets to and from the intra-consist router in parallel with the wired Ethernet bridge.

### TECHNICAL FIELD

The present disclosure relates generally to a communication network, and more particularly, to a parallel path communication network for use on a train.

### BACKGROUND

A consist includes one or more locomotives that are coupled together to produce motive power for a train of rail vehicles. The locomotives each include one or more engines, which combust fuel to produce mechanical power. The engine(s) of each locomotive can be supplied with liquid fuel (e.g., diesel fuel) from an onboard tank, gaseous fuel (e.g., natural gas) from a tender car, or a blend of the liquid and gaseous fuels. The mechanical power produced by the combustion process is directed through a generator and used to generate electricity. The electricity is then routed to traction motors of the locomotives, thereby generating torque that propels the train. The locomotives can be connected together at the front of the train or separated and located at different positions along the train. For example, the consist can be positioned at the front, middle, or end of the train. In some instances, more than one consist can be included within a single train. In some consists, the locomotives include computer systems for maintaining operations of the locomotive.

Because the locomotives of a consist must cooperate to propel the train, communication between the locomotives can be important. Historically, this communication has been facilitated through the use of an MU (Multi-Unit) cable that extends along the length of the consist. An MU cable is comprised of many different wires, each capable of carrying a discrete signal used to regulate a different aspect of consist operation. For example, a lead locomotive generates current within a particular one of the wires to indicate a power level setting requested by the train operator. When this wire is energized, the engines of all trailing locomotives are caused to operate at a specific throttle value. In another example, when one locomotive experiences a fault condition, another of the wires is energized to alert the other locomotives of the condition's existence.

In some consists, locomotives communicate via their respective computer systems on an Ethernet network thrilled over the MU cables, or other intra-consist electrical cables. With this configuration, network data can be transmitted from the computer system in the lead locomotive to the computer systems in the trail locomotives, and vice-versa. The network data includes data that is packaged as data packets and uniquely addressed to particular computer systems, or portions of the computer systems. The network data can be, for example, vehicle sensor data indicative of vehicle health, commodity condition data, temperature data, weight data, and security data. The network data is transmitted orthogonal to conventional non-network (i.e., command) data that is already being transmitted on the MU cable.

While MU cables provide an existing infrastructure that can be used by the computer systems of locomotives to communicate network data, MU cables can be problematic in some applications. For example, the MU cables can become damaged during normal use. And because each MU cable consists of many different wires, it can be difficult to pinpoint and fix the wire or wires that are damaged.

One attempt to improve communication within a train is described in U.S. Pat. No. 8,200,381 (the '381 patent) of Carroll that issued on Jun. 12, 2012. The '381 patent describes a communication network having portions of the network that are hard wired and portions that are wireless. Specifically, each car of the train includes an inter component link (ICL) located at each end, and a wired network that runs between the links and throughout each car. The ICLs of a single car can communicate with each other via the wired network, but may only communicate with ICLs of adjacent cars via the wireless network.

Although the communication network disclosed in the '381 patent may avoid some of the disadvantages of an all-wired network, it may still be problematic. In particular, wireless communication may be unreliable, for example due to interference experienced within tunnels or when passing through other terrain features. In addition, having a single path for communication could limit an amount of data that can be communicated between cars.

The disclosed communication network is directed to overcoming one or more of the problems set forth above.

### SUMMARY

In one aspect, the present disclosure is directed to a communication access point for use with a mobile consist having at least a first vehicle and a second vehicle. The communication access point may include an intra-consist router configured to receive signals from a first plurality of vehicle control components located onboard the first vehicle and to generate data packets for transmission to a second plurality of vehicle control components located onboard the second vehicle. The communication access point may also include a wired Ethernet bridge configured to transmit data packets to and from the intra-consist router, and a wireless Ethernet bridge configured to transmit data packets to and from the intra-consist router in parallel with the wired Ethernet bridge.

In another aspect, the present disclosure is directed to a communication network for a mobile consist having at least a first vehicle and a second vehicle. The communication network may include a first access point located onboard the first vehicle. The first access point may have a first plurality of vehicle control components configured to generate or receive control signals affecting operation of the first vehicle, and a LAN hub located onboard the first vehicle and connected to the first plurality of vehicle control components. The first access point may also have an intra-consist router located onboard the first vehicle and configured to receive signals from the LAN hub and to generate data packets for transmission to the second vehicle. The first access point may further have a wired Ethernet bridge configured to transmit data packets to and from the intra-consist router, and a wireless Ethernet bridge configured to transmit data packets to and from the intra-consist router in parallel with the wired Ethernet bridge. The communication network may also include a second access point substantially identical to the first access point and located onboard the second vehicle, a multi-unit cable connecting the wired Ethernet bridges of the first and second access points, and a plurality of antennae connecting the wireless Ethernet bridges of the first and second access points.

In yet another aspect, the present disclosure is directed to a train consist. The train consist may include a first locomotive, a second locomotive, and a tender car. The train consist may also include a first access point located onboard the first locomotive and being configured to control operations of the first locomotive, and a second access point located onboard one of the second locomotive and the tender car and being configured to control operations of the one of the second locomotive and the tender car. The train consist may further include a multi-unit cable connecting the first and second access points to communicate signals associated with coordinated control over operations of the first locomotive, the tender car, and/or the second locomotive, and a plurality of antennae connecting the first and second access points to communicate signals associated with coordinated control over operations of the first locomotive, the tender car, and/or the second locomotive in parallel with the multi-unit cable. Each of the first and second access points may have a LAN hub connected to a plurality of vehicle control components, an intra-consist router configured to receive signals from the LAN hub and to generate data packets for transmission, a wired Ethernet bridge configured to transmit data packets to and from the intra-consist router, and a wireless Ethernet bridge configured to transmit data packets to and from the intra-consist router in parallel with the wired Ethernet bridge. Each of the first and second access points may further have a multi-unit modem connected between the wired Ethernet bridge and the multi-unit cable, and an Ethernet switch connected between the intra-consist router and the wired and wireless Ethernet bridges. The Ethernet switch may be configured to selectively direct data packets through one of the wired or wireless Ethernet bridges, and to selectively disable the other of the wired and wireless Ethernet bridges.

### BRIEF DESCRIPTION OF THE DRAWINGS

FIG. 1 is a pictorial illustration of an exemplary disclosed consist; and

FIG. 2 is a diagrammatic illustration of an exemplary disclosed communication system that may be used in conjunction with the consist of FIG. 1.

### DETAILED DESCRIPTION

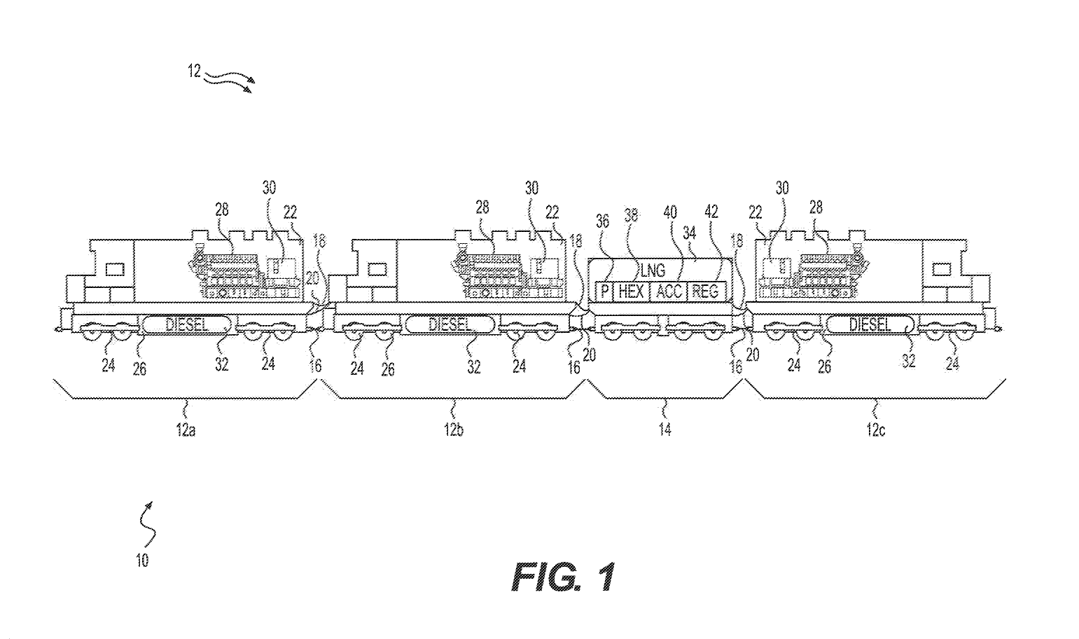

FIG. 1 illustrates an exemplary train consist 10 having one or more locomotives 12 and a tender car 14. In the disclosed embodiment, consist 10 has three different locomotives 12, including a lead locomotive 12a located ahead of tender car 14 and two trailing locomotives 12h, 12c located behind tender car 14. It is contemplated, however, that consist 10 may include any number of locomotives 12 and/or tender cars 14, and that locomotives 12 may be disposed in any arrangement relative to tender car(s) 14 and in any orientation (e.g., forward-facing or rear-facing). Consist 10 may be located at the front of a train of other rail vehicles (not shown), within the train of rail vehicles, or at the end of the train of rail vehicles. It is also contemplated that more than one consist 10 may be included within a single train of rail vehicles, if desired, and/or that consist 10 may travel at times without a train of other rail vehicles.

Each locomotive 12 may be connected to an adjacent locomotive 12 and/or tender car 14 in several different ways. For example, locomotives 12 and tender car 14 may be connected to each other via a mechanical coupling 16, one or more fluid couplings 18, and one or more electrical couplings 20. Mechanical coupling 16 may be configured to transmit tractive and braking forces between locomotives 12 and tender car 14. Fluid couplings 18 may be configured to transmit fluids (e.g., fuel, coolant, lubricant, pressurized air, etc.) between locomotives 12 and tender car 14. Electrical couplings 20 may be configured to transmit power and/or data (e.g., data in the form of electrical signals) between locomotives 12 and tender car 14, in one example, electrical couplings 20 include an MU cable configured to transmit conventional command signals and/or electrical power. In another example, electrical couplings 20 include a dedicated data link configured to transmit packets of data (e.g., Ethernet data), as will be discussed in more detail below. In yet another example, the data packets may be transmitted via the MU cable. It is also contemplated that some data may be transmitted between locomotives 12 and tender car 14 via a combination of the MU cable, the dedicated data link, and/or other means (e.g., wirelessly—explained in more detail below), if desired.

Each locomotive 12 may include a car body 22 supported at opposing ends by a plurality of trucks 24 (e.g., two trucks 24). Each truck 24 may be configured to engage a track (not shown) via a plurality of wheels, and to support a frame 26 of car body 22. Any number of engines 28 may be mounted to frame 26 within car body 22 and drivingly connected to a generator 30 to produce electricity that propels the wheels of each truck 24. Engines 28 may be internal combustion engines configured to combust a mixture of air and fuel. The fuel may include a liquid fuel (e.g., diesel) provided to engines 28 from a tank 32 located onboard each locomotive 12, a gaseous fuel (e.g., natural gas) provided by tender car 14 via fluid couplings 18, and/or a blended mixture of the liquid and gaseous fuels.

Tender car 14, like locomotives 12, may also be equipped with a frame 26 that is supported by two or more trucks 24. Tender car 14 may also include one or more tanks 34 mounted to its frame 26 that are configured to store liquefied gaseous fuel (e.g., liquefied natural gas or LNG). The liquefied gaseous fuel may be gasified and then fed in series or parallel to all locomotives 12 of consist 10 for combustion within engines 28. In the disclosed embodiment, a single insulated tank 34 is used to store the liquefied gaseous fuel at low temperatures, such as below about −160° C. In some embodiments, tank 34 may be integral with frame 26 of tender car 14.

Additional fuel delivery components may be associated with tender car 14 and used to gasify and/or transport the fuel from tender car 14 to locomotives 12. These components may include, among other things, one or more fuel pumps 36, one or more heat exchangers 38, one or more accumulators 40, one or more regulators 42, and associated conduits (not shown) that condition, pressurize or otherwise move fuel, as is known in the art.

Pump(s) 36 may be situated near or within tank 34, and embody, for example, cryogenic pumps, piston pumps, centrifugal pumps, or any other pumps that are known in the industry. Pumps 36 may primarily be powered with electricity supplied via couplings 20 from generators 30 located onboard locomotives 12 (e.g., onboard lead locomotive 12a). Additionally, or alternatively, pumps 36 may be powered by an electric storage system and/or an onboard auxiliary engine (not shown), if desired. Pumps 36 may pressurize the liquefied gaseous fuel to a desired operating pressure and push the fuel through heat exchanger(s) 38 to accumulator(s) 40. Heat exchanger(s) 38 may provide heat sufficient to gasify the fuel as it moves therethrough. Upon vaporization, the fuel may be transported to and stored within accumulator(s) 40. Although shown as being located onboard only tender car 14, it is contemplated that some or all of accumulator(s) 40 could alternatively be located onboard each locomotive 12. Gaseous fuel may be directed to engines 28 via regulator(s) 42.

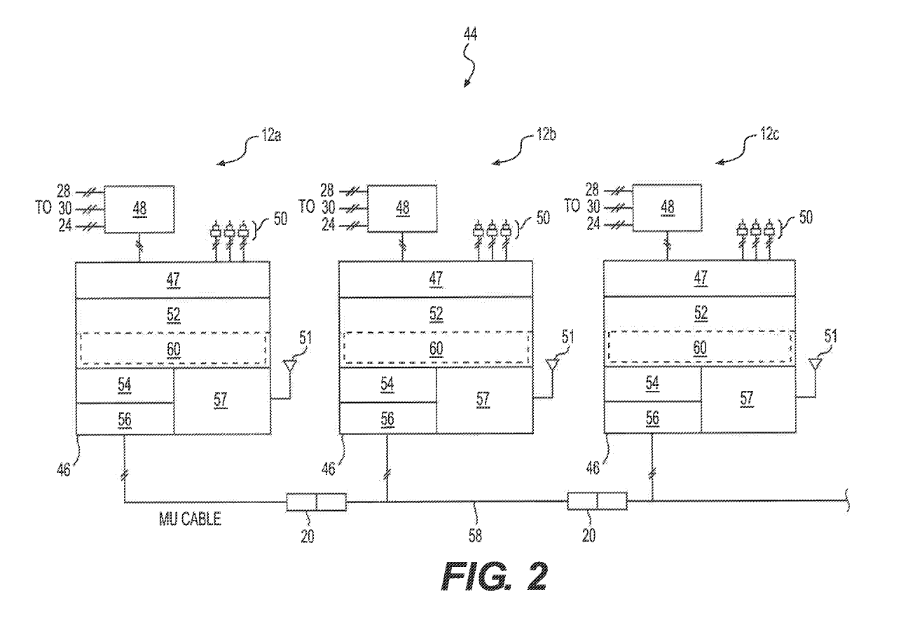

As shown in FIG. 2, consist 10 may be equipped with a communication system 44 that facilitates coordinated control of locomotives 12 and/or tender car 14. Communication system 44 may include, among other things, an access point 46 for each locomotive 12 and for tender car 14. Each access point 46 may be connected to a wired network and to a wireless network in parallel, and used to communicate command signals and/or data between controllers 48 of each rail vehicle and various other network components (e.g., sensor, valves, pumps, heat exchangers, accumulators, regulators, actuators, engines, generators, etc.) 50 that are used to control locomotives 12 and/or tender car 14. Access points 46 may be connected to each other via electrical couplings 20 (e.g., via the MU cable and/or the dedicated data link) and via wireless antennae 51. Access points 46 can be connected to a local area network hub (“LAN hub”) 47 that facilitates communication between the controllers 48, the network components 50, and access points 46.

Each access point 46 can include an intra-consist router (“IC router”) 52, a wired Ethernet bridge 54, an MU modem 56, and a wireless Ethernet bridge 57, as well as conventional computing components known in the art (not shown) such as a processor, input/output (I/O) ports, a storage, a memory. The I/O ports may facilitate communication between the associated access point 46 and the LAN hub 47. In some embodiments, the I/O ports may facilitate communication between the associated access point 46 and one or more of network components 50.

Likewise, IC router 52 can facilitate communication between different access points 46 of locomotives 12 that are connected to each other via electrical couplings 20 and wireless antennae 51. In some embodiments, IC router 52 can provide a proxy IP address corresponding to controllers 48 and network components 50 of remote locomotives. For example, IC router 52 can provide a proxy IP address for each of network components 50 of locomotive 12b, so that controller 48 of locomotive 12a can communicate with it. The IC router 52 can include, or be connected to, the corresponding wired Ethernet bridge 54 and wireless Ethernet bridge 57, each of which is configured to translate network data to an electrical signal capable of being sent through an intra-consist electrical cable 58 within electronic coupling 20 or over antennae 51, respectively.

Wired Ethernet bridge 54 can include or be connected to MU modem 56. MU modem 56 can be configured to modulate a carrier signal sent over intra-consist electrical cable 58 with the electrical signal received from Wired Ethernet bridge 54 to transmit network data between access points 46. MU modern 56 can also be configured to demodulate signals received from access points 46 and send the demodulated signals to Wired Ethernet bridge 54 for conversion to network data destined to controller 48 or network components 50. In some embodiments, MU modem 56 sends network data orthogonal to data traditionally transmitted over intra-consist electrical cable 58 (e.g., control data). Although FIG. 2 illustrates IC router 52, Wired Ethernet bridge 54, and MU modem 56 as separate components, in some embodiments, one component could alternatively perform the functionality of two or more components. For example, Wired Ethernet bridge 54 may perform the operations described above with respect to IC router 52, or Wired Ethernet bridge 54 can include, or perform the operations of, MU modem 56.

Like Wired Ethernet bridge 54, wireless Ethernet bridge 57 could also include or be connected to a wireless modem (not shown), if desired. The wireless modem would be configured to modulate a carrier signal sent over antennae 51 with the electrical signal received from wireless Ethernet bridge 57 to wirelessly transmit network data between access points 46. The wireless modem could also be configured to demodulate signals received from access points 46 and send the demodulated signals to wireless Ethernet bridge 57 for conversion to network data destined to controller 48 or network components 50. In the disclosed embodiment, wireless Ethernet bridge 57 performs the functionality of the wireless modem.

Each of access point 46, IC router 52, wired Ethernet bridge 54, MU modem 56, and wireless Ethernet bridge 57 can include a processor, storage, and/or memory (not shown). The processor can include one or more processing devices, such as microprocessors and/or embedded controllers. The storage can include volatile or non-volatile, magnetic, semiconductor, tape, optical, removable, non-removable, or other type of computer-readable medium or computer-readable storage device. The storage can be configured to store programs and/or other information that can be used to implement one or more of the processes discussed below. The memory can include one or more storage devices configured to store information.

Each controller 48 can be configured to control operational aspects of its related rail vehicle. For example, controller 48 of lead locomotive 12a can be configured to control operational aspects of its corresponding engine 28, generator 30, traction motors, operator displays, and other associated components. Likewise, the controllers 48 of trail locomotives 12b and 12c can be configured to control operational aspects of their corresponding engines 28, generators 30, traction motors, operator displays, and other associated components. In some embodiments, controller 48 of lead locomotive can be further configured to control operational aspects of trail locomotives 12b and/or 12c, if desired. For example, controller 48 of lead locomotive 12a can send commands through its access point 46 to the access points of trail locomotives 12b and 12c. Controller 48 of tender car 14 may be configured to control operational aspects of pump(s) 36, heat exchanger(s) 38, accumulator(s) 40, regulator(s) 42, and other associated tender car components.

Each controller 48 can embody a single microprocessor or multiple microprocessors that include a means for controlling an operation of the associated rail vehicle based on information obtained from any number of network components 50 and/or communications received via access points 46. Numerous commercially available microprocessors can be configured to perform the functions of controller 48. Controller 48 can include a memory, a secondary storage device, a processor, and any other components for running an application. Various other circuits may be associated with controller 48 such as power supply circuitry, signal conditioning circuitry, solenoid driver circuitry, and other types of circuitry.

The information obtained by a particular controller 48 via access points 46 and/or network components 50 can include performance related data associated with operations of each locomotive 12 and/or tender car 14 (“operational information”). For example, the operational information can include engine related parameters (e.g., speeds, temperatures, pressures, flow rates, etc.), generator related parameters (e.g., speeds, temperatures, voltages, currents, etc.), operator related parameters (e.g., desired speeds, desired fuel settings, locations, destinations, braking, etc.), liquid fuel related parameters (e.g., temperatures, consumption rates, fuel levels, demand, etc.), gaseous fuel related parameters (e.g., temperatures, supply rates, fuel levels, etc.), and other parameters known in the art.

The information obtained by a particular controller 48 via access points 46 and/or network components 50 can also include identification data of the other rail vehicles within the same consist 10. For example, each controller 48 can include stored in its memory the identification of the particular rail vehicle with which controller 48 is associated. The identification data can include, among other things, a type of rail vehicle (e.g., make, model, and unique identification number), physical attributes of the associated rail vehicle (e.g., size, load limit, volume, power output, power requirements, fuel consumption rate, fuel supply capacity, etc.), and maintenance information (e.g., maintenance history, time until next scheduled maintenance, usage history, etc.). When coupled with other rail vehicles within a particular consist 10, each controller 48 can be configured to communicate the identification data to the other controllers 48 within the same consist 10. Each controller 48, can also be configured to selectively affect operation of its own rail vehicle based on the obtained identification data associated with the other rail vehicles of consist 10.

In some embodiments, controllers 48 can be configured to affect operation of their associated rail vehicles based on the information obtained via access points 46 and/or network components 50 and one or more maps stored in memory. Each of these maps may include a collection of data in the form of tables, graphs, and/or equations.

In the exemplary system shown in FIG. 2, IC router 52 may be configured to utilize separate interfaces when communicating with wired Ethernet bridge 54 and wireless Ethernet bridge 57. In this configuration, IC router 52 may itself manage the sending of data packets via the two bridges. In one embodiment, this management may be done by the router application itself or by operating system software programmed into IC router 52, as desired. This management may include, among other things, link health detection, link aggregation, and load balancing, In addition, the operating system software may authenticate received data packets as being sent from components 50 onboard one of locomotives 12 within consist 10 (to ensure that communication is only within the same train), or configure bridges 54, 57 with security features that allow acceptance of data packets from only authenticated devices.

In an alternative embodiment also shown in FIG. 2, each access point 46 may further include a dedicated Ethernet switch 60 disposed between IC router 52 and bridges 54, 57. In this configuration, switches 60 may use a spanning tree protocol (STP) to communicate between access points 46, such that packet forwarding and endless data looping is inhibited. In this configuration, data packets may be sent between access points 46 of different locomotives 12 via either coupling 20 or antennae 51, but not simultaneously via both communication paths. If a primary path (e.g., coupling 20 or antennae 51) were to fail, switches 60 may function to redirect the data packets to the remaining functional path. In this way, communication system 44 includes parallel, backup, and/or redundant communication means.

In either embodiment (i.e., in the embodiment without switches 60 or the embodiment with switches 60), usage of the different communication paths may be managed. The primary difference between the embodiments is associated with either IC router 52 performing the management function or switches 60 performing the management function. Thus, in either configuration, for each communication of data packets, the two communication paths will be scrutinized. One of the paths may then be selected for use in transmission of the data packets, and the other may be disabled. Any logic known in the art may be utilized to select the desired path for transmission. For example, a particular path may be selected based on a current or future position of consist 10 (e.g., within a tunnel, entering a tunnel, or outside of a tunnel). Similarly, a particular path may be selected based on monitored performance (e.g., interference), bandwidth, a known failure, or other similar condition.

In some embodiments, a particular communication path may be selected to communicate particular packets of information. For example, when communicating between a first type of components 50 of locomotives 12, one path may be chosen, whereas communication between other components 50 may be performed via the other path. This may allow for customized communication of data packets of varying bandwidth requirements to be efficiently accommodated via different paths with varying capacities.

In some embodiments, duplicate packets of data may be broadcast via both communication paths (i.e., via coupling 20 and via antennae 51). In this configuration, IC router 52 may receive both communications, and discard any duplicate packets. The packets that are discarded may include packets received with reduced integrity (i.e., low quality packets).

### INDUSTRIAL APPLICABILITY

The disclosed communication network can be applicable to any consist that includes a plurality of vehicles (e.g., rail vehicles), such as locomotives and tender cars. The disclosed communication network may provide high quality signal transmission and receipt over a variety of different configurations and conditions, resulting in finer control over consist operation.

Several advantages may be associated with the disclosed communication network. Specifically, the disclosed system may be reliable, as a backup communication path may always be available should a first path fail or experience interference. Further, the bandwidth for communication may be expanded, in some applications, due to the use of two different communication paths.

It will be apparent to those skilled in the art that various modifications and variations can be made to the disclosed communication network without departing from the scope of the disclosure. Other embodiments of the communication network will be apparent to those skilled in the art from consideration of the specification and practice of the communication network disclosed herein. It is intended that the specification and examples be considered as exemplary only, with a true scope being indicated by the following claims and their equivalents.

1. A communication access point for a mobile consist having at least a first vehicle and a second vehicle, comprising:
an intra-consist router configured to receive signals from a first plurality of vehicle control components located onboard the first vehicle and to generate data packets for transmission to a second plurality of vehicle control components located onboard the second vehicle;
a wired Ethernet bridge configured to transmit data packets to and from the intra-consist router and to translate the data packets into electrical signals capable of being sent through an intra-consist electrical cable; and
a wireless Ethernet bridge configured to transmit data packets to and from the intra-consist router in parallel with the wired Ethernet bridge and to translate the data packets into electrical signals capable of being sent over an antenna.

2. The communication access point of claim 1, further including a LAN hub connected between the intra-consist router and the first plurality of vehicle control components.

3. The communication access point of claim 2, wherein:
the wired Ethernet bridge is configured to transmit and receive data packets over a multi-unit cable that extends between the at least a first and second vehicles; and
the wireless Ethernet bridge is configured to transmit and receive data packets wirelessly via antennae located on the at least a first and second vehicles.

4. The communication access point of claim 3, further including a multi-unit modem connected between the wired Ethernet bridge and the multi-unit cable.

5. The communication access point of claim 1, wherein the intra-consist router is configured to manage sending of data packets via the wired Ethernet bridge and the wireless Ethernet bridge.

6. The communication access point of claim 5, wherein:
the wired Ethernet bridge forms a portion of a first communication path;
the wireless Ethernet bridge forms a portion of a second communication path in parallel with the first communication path; and
the intra-consist router is further configured to manage link health detection, link aggregation, and load balancing on the first and second communication paths.

7. The communication access point of claim 6, wherein the intra-consist router is further configured to authenticate received data packets as being sent from components onboard the second vehicle.

8. The communication access point of claim 1, further including an Ethernet switch connected between the intra-consist router and the wired and wireless Ethernet bridges.

9. The communication access point of claim 8, wherein the Ethernet switch is configured to manage sending of data packets via the wired Ethernet bridge and the wireless Ethernet bridge.

10. The communication access point of claim 9, wherein the Ethernet switch is configured to use a spanning tree protocol to manage the sending of data packets.

11. The communication access point of claim 9, wherein the Ethernet switch is configured to selectively direct data packets through one of the wired or wireless Ethernet bridges, and selectively disable the other of the wired and wireless Ethernet bridges.

12. The communication access point of claim 11, wherein the Ethernet switch is configured to selectively direct data packets through one of the wired or wireless Ethernet bridges based on a required bandwidth of the data packets.

13. The communication access point of claim 9, wherein the Ethernet switch is configured to transmit duplicate data packets via each of the wired and wireless Ethernet bridges, and selectively discard received data packets that are duplicates.

14. The communication access point of claim 13, wherein duplicate data packets that are discarded by the Ethernet switch are low quality data packets.

15. A communication network for a mobile consist having at least a first vehicle and a second vehicle, comprising:
a first access point located onboard the first vehicle and having:
a first plurality of vehicle control components configured to generate or receive control signals affecting operation of the first vehicle;
a LAN hub located onboard the first vehicle and connected to the first plurality of vehicle control components;
an intra-consist router located onboard the first vehicle and configured to receive signals from the LAN hub and to generate data packets for transmission to the second vehicle;
a wired Ethernet bridge configured to transmit data packets to and from the intra-consist router and to translate the data packets into electrical signals capable of being sent through an intra-consist electrical cable; and
a wireless Ethernet bridge configured to transmit data packets to and from the intra-consist router in parallel with the wired Ethernet bridge and to translate the data packets into electrical signals capable of being sent over an antenna;
a second access point substantially identical to the first access point and located onboard the second vehicle;
a multi-unit cable connecting the wired Ethernet bridges of the first and second access points; and
a plurality of antennae connecting the wireless Ethernet bridges of the first and second access points.

16. The communication network of claim 15, wherein each of the first and second access points includes a multi-unit modem connected between the wired Ethernet bridge and the multi-unit cable.

17. The communication network of claim 16, wherein each of the first and second access points includes an Ethernet switch connected between the intra-consist router and the wired and wireless Ethernet bridges.

18. The communication network of claim 17, wherein the Ethernet switch is configured to selectively direct data packets through one of the wired or wireless Ethernet bridges, and selectively disable the other of the wired and wireless Ethernet bridges.

19. The communication network of claim 18, wherein the Ethernet switch is configured to transmit duplicate data packets via each of the wired and wireless Ethernet bridges, and selectively discard received data packets that are low quality duplicates.

20. A train consist, comprising:
a first locomotive;
a second locomotive;
a tender car;
a first access point located onboard the first locomotive and being configured to control operations of the first locomotive;
a second access point located onboard one of the second locomotive and the tender car and being configured to control operations of the one of the second locomotive and the tender car;
a multi-unit cable connecting the first and second access points to communicate signals associated with coordinated control over operations of the first locomotive, the tender car, and/or the second locomotive; and
a plurality of antennae connecting the first and second access points to communicate signals associated with coordinated control over operations of the first locomotive, the tender car, and/or the second locomotive in parallel with the multi-unit cable,
wherein each of the first and second access points includes:
a LAN hub connected to a plurality of vehicle control components;
an intra-consist router configured to receive signals from the LAN hub and to generate data packets for transmission;
a wired Ethernet bridge configured to transmit data packets to and from the intra-consist router and to translate the data packets into electrical signals capable of being sent through an intra-consist electrical cable;
a wireless Ethernet bridge configured to transmit data packets to and from the intra-consist router in parallel with the wired Ethernet bridge and to translate the data packets into electrical signals capable of being sent over an antenna;
a multi-unit modem connected between the wired Ethernet bridge and the multi-unit cable; and
an Ethernet switch connected between the intra-consist router and the wired and wireless Ethernet bridges, the Ethernet switch configured to selectively direct data packets through one of the wired or wireless Ethernet bridges, and to selectively disable the other of the wired and wireless Ethernet bridges.
